(19) United States
(12) Patent Application Publication
(10) Pub. No.: US 2010/0068399 A1
(43) Pub. Date: Mar. 18, 2010

(54) METHOD FOR THE PRODUCTION OF A MULTILAYER STRUCTURE

(75) Inventors: Dmity Chernyshov, Moscow (RU); Uwe Wilkenhoener, Wuppertal (DE)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I DU PONT DE NEMOURS AND COMPANY, Wilmington, DE (US)

(21) Appl. No.: 12/517,644

(22) PCT Filed: Dec. 5, 2007
(86) PCT No.: PCT/US07/25007

§ 371 Date: Jun. 4, 2009

Related U.S. Application Data
(60) Provisional application No. 60/873,885, filed on Dec. 8, 2006.

(51) Int. Cl. B05D 3/02

(52) U.S. Cl. 427/385.5

(57) ABSTRACT

The invention relates to a method for the production of a multilayer structure, comprising the steps 1. applying a functional layer onto an optionally precoated substrate, 2. curing the coating applied in this manner and 3. applying an adhesive onto the cured coating, wherein the functional layer is applied from a water-based coating composition which comprises
A) at least one aqueous polymer latex, selected from the group consisting of (meth)acrylate latex, polydiene latex, polydiene copolymer latex, polystyrene latex, nitrile latex and mixtures thereof, and
B) at least one amino resin.

### BACKGROUND OF THE INVENTION

The invention relates to a method for the production of a multilayer structure from at least one coating layer and an adhesive layer, which method is in particular used for the interior coating of vehicle bodies.

### DESCRIPTION OF RELATED ART

Water-based compositions and coating compounds which contain a combination of melamine resins and various polymer lattices, such as for example (meth)acrylate lattices, are already known.

U.S. Pat. No. 5,166,254, for example, accordingly describes a water-based composition containing a methylol (meth)acrylamide-based (meth)acrylate latex, an acrylate hydrosol and a water-soluble or water-dispersible alkylated melamine-formaldehyde resin. These compositions are used as clearcoat materials or pigmented coating materials, for example as colour-imparting base coats or primers, in vehicle coating.

U.S. Pat. No. 6,406,596 furthermore describes additives for cement applications which contain melamine resin, cellulose ether and acrylate, styrene or butadiene lattices.

It is conventional, in the interior coating of vehicle bodies, in particular bus bodies, to apply for example an functional interlayer onto the body, in particular the floor of the body. The vehicle body can be pre-coated for example with a primer, for example a CED primer (CED=cathodic electro-dipcoating). An adhesive may then be applied to the interlayer and suitable flooring sheets, on which in turn vehicle seats can be fitted, or other interior coverings are then stuck onto the adhesive layer. The crucial requirement placed on this multilayer structure is the adhesion between the different layers, i.e. the adhesion between the pre-coated vehicle body and the functional layer on the one hand and the adhesion between the functional layer and the adhesive layer on the other hand. However, known coatings of this kind, for example based on epoxide/polyamine systems, still always exhibit inadequate adhesion in the overall structure, i.e. in particular inadequate adhesion of the functional layer to the pre-coated vehicle body and also to the adhesive layer.

There is accordingly still a requirement for a multilayer structure prepared from a functional interlayer and an adhesive layer on an optionally pre-coated substrate with excellent interlayer adhesion, even after exposure to extreme conditions, for example after exposure to moist heat for more than 100 hours, on the one hand and very good flexibility and mechanical resistance on the other hand. The functional interlayer should here also cure well at temperatures as low as ambient temperature or under forced conditions at temperatures of up to approx. 80° C.

### SUMMERY OF THE INVENTION

The invention relates to a method for the production of a multilayer structure, in particular for use in the interior coating of vehicle bodies, such as bus bodies or comparable vehicle bodies, comprising the steps:

1. Applying a functional coating layer onto an optionally precoated substrate,

2. Curing the coating applied in this manner and

3. Applying an adhesive onto the cured coating, wherein the adhesive may be applied over the entire coating surface or just a part thereof,

and wherein the functional coating layer is applied from a water-based coating composition which comprises:

A) at least one aqueous polymer latex, selected from the group consisting of (meth)acrylate latex, polydiene latex, polydiene copolymer latex, polystyrene latex, nitrile latex and mixtures thereof, and

B) at least one amino resin, preferably at least one water-dispersible amino resin.

The coating composition forming the functional coating layer preferably contains 10-70 wt. % of component A) and 1-20 wt. % of component B), particularly preferably 20-50 wt. % of component A) and 3-12 wt. % of component B), relative to the entire water-based coating composition, wherein wt. % are based on the resin solids of component A) and B).

### DETAILED DESCRIPTION OF THE EMBODIMENTS

The invention will be explained in greater detail below.

It will be appreciated that certain features of the invention which are, for clarity, described above and below in the context of separate embodiments may also be provided in combination in a single embodiment. Conversely, various features of the invention that are, for brevity, described in the context of a single embodiment may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both preceded by the word “about”. Thus, slight variations above and below the stated ranges can be used to achieve substantially the same results as values within the ranges. Moreover, in the disclosure of these ranges, a continuous range is intended, covering every value between the minimum and maximum values, including the minimum and maximum end points of the range.

By “aqueous polymer latex”, it is meant water-dispersed emulsion polymer, i.e. water-dispersed polymer particles prepared by emulsion polymerizing free-radically polymerizable olefinically unsaturated monomers in the aqueous phase.

The term (meth)acrylic as used here and hereinafter should be taken to mean methacrylic and/or acrylic and wt. % should be taken to mean weight percentage.

Unless stated otherwise, all molecular weights (both number and weight average molecular weight) referred to herein are determined by GPC (gel permeation chromatographie) using polystyrene as the standard.

Water-based coating compositions are coating compositions, wherein water is used as solvent or thinner when preparing and/or applying the coating composition. Usually, water-based coating compositions contain 30 to 90% by weight of water, based on the total amount of the coating composition and optionally, up to 15% by weight, preferably, below 10% by weight of organic solvents, based on the total amount of the coating composition.

The coating composition forming the functional coating layer applied in step 1 will first of all be described in greater detail.

This comprises a water-based coating composition comprising the binder components A and B, water and optionally conventional coating additives, organic solvents, fillers and/or pigments.

The water-based coating composition preferably contains 20-60 wt. %, preferably 30-50 wt. % of components A and B (stated as resin solids content), 20-40 wt. %, preferably 25-35 wt. % of water and 20-40 wt. %, preferably 25-35 wt. % of conventional coating additives, organic solvents, fillers and/or pigments, wherein the weight percentages of the individual components add up to 100 wt. %.

The at least one aqueous latex to be used according to the invention (component A) comprises, as already defined above, polymers or copolymers produced in the aqueous phase by means of emulsion polymerisation of free-radically polymerisable olefinically unsaturated monomers. Lattices based on (meth)acrylates, polydienes, polydiene copolymers, nitriles and polystyrene may be used individually or in combination.

Generally the aqueous lattices can be produced by a single-stage or multistage emulsion polymerization, i.e. the olefinically unsaturated monomers to be free-radically polymerized are polymerized under conventional conditions known to the person skilled in the art of a free-radical polymerization performed in an aqueous emulsion, i.e. using for example one or more emulsifiers and with the addition of one or more initiators which are thermally dissociable into free radicals.

The emulsifier(s) is/are used in a conventional total quantity of, for example, 0.1 to 3 wt. %, relative to the sum of the weight of monomers. Examples of usable emulsifiers are the conventional cationic, anionic and nonionic emulsifiers usable in the context of emulsion polymerization, such as, for example, acetyltrimethylammonium chloride, benzyldodecyldimethylammonium bromide, sodium dodecyl sulfate, sodium dodecylbenzenesulfonate, polyethylene glycol monolauryl ether. Care must be taken to ensure that cationic and anionic emulsifiers are not used with one another.

The initiator(s) which are thermally dissociable into free radicals (free-radical initiators) are used in a conventional total quantity of, for example, 0.02 to 2 wt. %, relative to the sum of the weight of monomers. The free-radical initiators are preferably water-soluble. Examples of usable free-radical initiators are hydrogen peroxide, peroxodisulfates such as sodium, potassium and ammonium peroxodisuifate, ammonium salts of 4,4′-azobis(4-cyanopentanoic acid), 2,2′-azobis(2-methyl-N-1,1-bis(hydroxymethyl)ethyl)propionamide, 2,2′-azobis(2-methyl-N-2-hydroxyethyl)propionamide as well as conventional redox initiator systems known to the person skilled in the art, such as hydrogen peroxide/ascorbic acid optionally in combination with catalytic metal salts such as iron, copper or chromium salts.

The (meth)acrylic lattices are produced by free-radical polymerization of (meth)acrylic monomers and optionally other olefinically unsaturated comonomers in the aqueous phase. Preferably the (meth)acrylic polymer comprises 60-100% by weight of (meth)acrylic monomers and may contain 0-40% by weight of non-(meth)acrylic olefinically polyunsaturated, free-radically polymerizable monomers.

Examples of free-radically polymerizable monomers to be used for preparing the (meth)acrylic lattices are those comprising functional groups or those being non-functionalized. They may also be used in combination.

Examples of free-radically polymerizable (meth)acrylic monomers without functional groups are (cyclo)alkyl(meth)acrylates. Examples of (cyclo)alkyl(meth)acrylates are (cyclo)alkyl(meth)acrylates with 1-12 carbon atoms, such as methyl(meth)acrylate, ethyl(meth)acrylate, propyl(meth)acrylate, butyl(meth)acrylate, isobutyl(meth)acrylate, tert.-butyl(meth)acrylate, hexyl(meth)acrylate, cyclohexyl(meth)acrylate, ethylhexyl(meth)acrylate, decyl(meth)acrylate, dodecyl(meth)acrylate, hexadecyl(meth)acrylate, lauryl(meth)acrylate and isobornyl(meth)acrylate.

Examples of olefinically unsaturated, free-radically polymerizable monomers with functional groups which may be used are in particular olefinically unsaturated, free-radically polymerizable monomers with at least one carboxyl group, such as, for example, (meth)acrylic, itaconic, crotonic, isocrotonic, aconitic, maleic and fumaric acid, semi-esters of maleic and fumaric acid and carboxyalkyl esters of (meth)acrylic acid, for example, beta-carboxyethyl acrylate and adducts of hydroxyalkyl(meth)acrylates with carboxylic anhydrides, such as, for example, phthalic acid mono-2-(meth)acryloyloxyethyl ester. (Meth)acrylic acid is preferred.

Furthermore olefinically unsaturated monomers with at least one hydroxyl group, such as allyl alcohol, but in particular hydroxyalkyl(meth)acrylates such as, for example, hydroxyethyl(meth)acrylate, and the hydroxypropyl(meth)acrylates, hydroxybutyl(meth)acrylates isomeric with regard to the position of the hydroxyl group, may be used.

(Meth)acrylamide monomers can also be used.

The (meth)acrylate monomers can be used in combination with further olefinically unsaturated, free-radically polymerizable monomers, such as for example, monovinyl aromatic compounds such as styrene, vinyltoluene; vinyl ethers and vinyl esters, such as vinyl acetate, vinyl versatate.

Even if not preferred, olefinically polyunsaturated, free-radically polymerizable monomers may also be used.

The (meth)acrylic polymer may contain at least one acid group, in particular at least one carboxyl group.

The acid groups of the (meth)acrylic polymer are preferably at least partially neutralized using conventional basic neutralizing agents, such as ammonia and in particular amines and/or aminoalcohols such as, for example, triethylamine, dimethylisopropylamine, dimethylethanolamine, dimethylisopropanolamine and 2-amino-2-methyl-1-propanol. Preferably the (meth)acrylic polymer contains (cyclo)alkyl(meth)acrylates, optionally in combination with further olefinically unsaturated, free-radically polymerizable monomers, such as styrene, vinyl acetate or (meth)acrylamides.

The (meth)acrylic lattices have e.g. a resin solids of 30-60% by weight and a viscosity of 100 to 3000 mPas (test method according to DIN 53019). The (meth)acrylic polymers have weight average molecular weights (Mw) of, for example, 100,000 to 1,000,000. Preferably (meth)acrylic polymers are used having a glass transition temperatures (Tg) of −10 to +30° C.

Suitable (meth)acrylic lattices are also commercially available. For example the following products can be used: UCAR Latex 120, 123, 163, 4358 (Union Carbide Corporation), Halwedrol EMP-TN 6536/50W (Hüttenes-Albertus Lackrohstoff GmbH),), Mowilith DM-774 (Celanese), Neocryl XK-87 (DSM NeoResins), Dilexo RA-4 (Dynea).

The polydiene, polydiencopolymer, nitrile and styrene lattices are also produced by free-radical polymerization of the respective olefinically unsaturated monomers.

Polydiene lattices are prepared by free-radical polymerization of diene monomers. Preferably used diene monomers are 1,3- and 1,4 dienes, such as 1,3-butadiene, 1,3-pentadiene, 1,4-pentadiene, 2-methyl-1,3-butadien (isoprene) and 2,3-dimethyl-1,3-butadiene. Especially preferred are lattices based on butadiene.

Polydiene copolymer lattices can also be used according to the present invention. Polydiene copolymers are polymers prepared by free-radical polymerization of diene monomers and at least one other olefinically unsaturated monomer. These are, for example, lattices based on copolymers of diene monomers and styrene, copolymers of diene monomers and nitrile monomers, such as (meth)acrylnitril, or terpolymers of diene monomers, styrene and nitrile monomers.

The polydiene copolymers may also contain smaller amounts of olefinically unsaturated (meth)acrylic monomers, for example in amounts of up to 30% by weight, based on the weight of the total copolymer. Examples of (meth)acrylic monomers are those described already above. Preferably butadiene-styrene copolymer lattices are used.

Furthermore nitrile lattices, e.g. based on acrylnitrile and/or methacrylnitrile and styrene lattices based on styrene and/or methyl styrene can be used according to the present invention. Nitrile lattices are lattices which substantially consist of olefinically unsaturated nitrile monomers and styrene lattices are lattices which substantially consist of styrene monomers. But they may contain also small amounts of other olefinically unsaturated comononers.

The polydiene, polydiencopolymer, nitrile and styrene lattices are commercially available. Products which can be used are for example Synthomer 3023 DF (styrene-butadiene copolymer) (Synthomer GmbH), Lipaton SB 5521 (styrene-butadiene copolymer from Polymer Latex GmbH and DL 475 (from Dow Reichhold Specialty Latex LLC).

The lattices of component A) can be used alone or in combination with each other. For example component A) can consist of at least one (meth)acrylate latex or can consist of at least one polydien latex and/or polydiencopolymer latex. Preferably at least one aqueous (meth)acrylate latex is used in combination with at least one polydien latex and/or polydiencopolymer latex. Especially preferred at least one aqueous (meth)acrylate latex is used in combination with at least one butadiene and/or butadiene-styrene copolymer latex.

The lattices described as component A) preferably contain acid groups, in particular carboxyl groups. The acid groups are preferably at least partially neutralised in order to ensure the requisite compatibility with water. Otherwise, the stated lattices preferably contain no further functional groups. They generally have weight-average molecular weights of 100,000 to 1,000,000. Lattices having a glass transition temperature (Tg) of −10 to +30° C. are preferably used. If lattices with a higher glass transition temperature are used, this may result in incomplete film formation and insufficient elasticity.

The above-described lattices A) may be produced using conventional methods known to the person skilled in the art. They may, for example, also be synthesised by the core-shell method.

The aminoplast resins (component C) to be used according to the invention are usual aminoplast resins as used for example in the coatings industry, in particular those which are suitable for use in water-borne coating compositions. They are products produced using known industrial processes by condensing compounds bearing amino or amido groups, such as, dicyandiamide, urea, glycoluril, but in particular triazines such as melamine, benzoguanamine or acetoguanamine with aldehydes, such as formaldehyde, paraformaldehyde, acetoaldehyde and benzaldehyde in the presence of alcohols. The preferred aldehyde is formaldehyde. Examples of alcohols are monohydric alcohols having 1- to 8 carbon atoms, such as methanol, ethanol, n-propanol, iso-propanol, iso-butanol, n-butanol, hexanol, 2-ethylbutanol and 2-ethylhexanol. The condensation products may be partially or completely etherified. The aminoplast resins can have different degrees of alkylolation and different degrees of etherification.

Melamine resins are preferably used as the aminoplast resins, in particular, those etherified to an extent of etherifying 3 to 6 alkylol groups out of 6 alkylol groups. Most preferred are completely etherified and, specifically, completely methanol-etherified types such as hexamethoxymethylmelamine. Monomeric as well as polymeric melamine resins can be used.

Examples of methyl-etherified melamine resins are the commercial products Cymel 301, Cymel 303, Cymel 325, Cymel 327, Cymel 350 and Cymel 370 from Cytec and Maprenal MF 927 and Maprenal MF 900 from Surface Specialties. Further examples are butanol- or isobutanol-etherified melamine resins such as, for example, the commercial products Setamin US 138 from Akzo and Maprenal MF 610 and Maprenal MF 3615 from Surface Specialties or co-etherified melamine resins, which are both butanol- and methanol-etherified, such as, for example, Cymel 254 from Cytec and Resimene HM from Ineos Melamines.

A combination of at least one (meth)acrylic latex with at least one polydiene latex, polydiene copolymer latex, nitrile latex and/or a polystyrene latex is preferably used according to the invention. A weight ratio of (meth)acrylic latex to polydiene latex, polydiene copolymer latex, nitrile latex and/or polystyrene latex of 20:80 to 80:20 is here used, preferably of 30:70 to 70:30 and in particular of 40:60 to 60:40, based on the resin solids content of the lattices. The (meth)acrylic latex here contributes to achieving sufficient hardness of the coating, while using the polydiene latex, polydiene copolymer latex, nitrile latex and/or polystyrene latex ensures sufficient flexibility of the coating.

A combination of a (meth)acrylic latex with a butadiene latex and/or a styrene/butadiene copolymer latex is particularly preferably used, preferably in a weight ratio of (meth)acrylic latex to butadiene latex and styrene/butadiene latex of 30:70 to 70:30, in particular of 40:60 to 60:40 (based on resin solids).

Using the stated lattices outside the above-stated quantity ranges results in impairment of the above-stated properties of the resultant coating, such as flexibility, hardness and abrasion resistance.

The proportion of the amino resin, in particular of the water-dispersible melamine resin preferably amounts to 1-20 wt. % (resin solids), relative to the entire coating composition. If the amino resin is used in quantities of below 1 wt. %, adequate adhesion of the functional layer to the underlying coating or to the adhesive layer is not achieved. If the amino resin is used in quantities of above 20 wt. %, this may result in insufficient drying as well as insufficient mechanical resistance, such as abrasion resistance.

Apart from the above-described binders A) and B) the coating composition forming the functional layer may contain further conventional binders, e.g. additional (meth)acrylate copolymers, polyurethane binders or polyester binders.

Apart from the above-described binders and water, the coating composition forming the functional layer may contain further conventional coating components, such as organic solvents, conventional coating additives, pigments and/or fillers.

The water-based coating compositions may contain the conventional coating additives in conventional quantities, for example, of 0.1 to 5 wt. %, relative to the solids content thereof. Examples are neutralizing agents, antifoaming agents, wetting agents, anticratering agents, thickeners and dispersant additives. Preferably the water-based coating compositions are free of curing catalysts for the curing reaction with aminoplast resins, in particular they are free of acid catalysts.

Examples of pigments are the conventional colored inorganic or organic pigments known to the person skilled in the art, such as, for example, titanium dioxide, iron oxide pigments, carbon black, azo pigments, phthalocyanine pigments, quinacridone pigments, pyrrolopyrrole pigments, perylene pigments.

The water-based coating compositions may contain conventional coating solvents, for example, in a proportion of preferably less than 15 wt. %, particularly preferably of less than 10 wt. %. These are conventional coating solvents, which may originate, for example, from the production of the binders or are added separately.

The water-based coating compositions have solids contents of, for example 30-80 wt. %, preferably of 50-70 wt. %.

Preferably the water-based coating compositions are used as two-component compositions, wherein one component comprises the binder components A) and the other component comprises the aminoplast resin B).

The further conventional coating components, such as organic solvents, conventional coating additives, pigments and/or fillers, may be present in one of the two or in both components. Storing the water-based coating compositions in one component may result in stability problems of the coating composition.

According to step 1 of the method according to the invention, the above-described water-based coating composition is applied onto the substrate which has optionally been precoated with a primer. The substrate here conventionally comprises metal, in particular a metal as is used for the production of vehicle bodies, for example steel. The metal substrate is preferably precoated with a primer, the primer in particular conventionally comprising a primer based on an electro-dipcoating, preferably a cathodically deposited electro-dipcoating.

The water-based coating compositions may be applied by conventional methods. They are preferably applied by spraying (e.g. airless or airmix) to a dry film thickness of, for example, 100 to 4000 μm, in particular of 200 to 3000 μm.

The water-based coating compositions which, according to the invention, form the functional layer may be cured at temperatures as low as ambient temperature, e.g. at about 20° C., or under forced conditions at temperatures of for example up to 80° C., for example within 60 to 300 minutes. Forced drying may proceed after flashing-off for approx. 10-30 minutes at room temperature. It was all the more surprising that the water-based coating composition should cure within reasonable times (of e.g. 30 to 300 minutes) at temperatures of, for example, up to at most 80° C. or even at ambient temperature and yield coatings with very good mechanical resistance, hardness and elasticity.

After curing of the functional layer according to step 2 of the method according to the invention, an adhesive is applied in step 3. This may proceed in conventional manner, for example by means of cartridges. The adhesive may be applied over the entire surface or just a part thereof in specific areas of the functional layer. A two-component polyurethane adhesive is preferably used. These adhesives conventionally contain hydroxy-functional binders, in particular based on polyester polyols, polyether polyols, poly(meth)acrylate polyols and combinations thereof, and polyisocyanate curing agents. But one-component adhesives can also be used.

Application of the adhesive here generally proceeds in a manner known to the person skilled in the art shortly before adhesive bonding of further material, for example shortly before sticking down flooring sheets or other interior coverings, as are used for fitting out vehicles such as buses, cars and further transportation vehicles.

The multilayer structure obtained according to the invention exhibits extraordinarily good adhesion between a pre-coated substrate, in particular between a substrate pre-coated with a primer coat, in particular a CED primer, and the functional layer and between the functional layer and the applied adhesive. This very good adhesion is also achieved after exposure to extreme conditions, in particular exposure to moist heat, for example at 100% relative atmospheric humidity and 40-60° C. for 120-240 hours. The multilayer structure obtained according to the invention likewise exhibits a very good appearance and mechanical resistance, flexibility and hardness. The functional layer may be cured at temperatures as low as room temperature or under forced conditions at up to 80° C., without it being necessary to accept any reduction in quality with regard to coating properties. No stoving at elevated temperatures, of for example 100 to 140° C., is necessary.

The method according to the invention may readily be used in the production and (interior) coating of vehicles (vehicle bodies), such as buses or similar vehicles, where components have to be applied onto a coating by means of an adhesive joint. The method may of course also readily be used for any desired other industrial purposes in which the above-described coating structure is necessary.

In the multilayer structure to be obtained according to the invention, the functional layer in particular serves to create the bonding layer between e.g. a primer and an adhesive layer. The functional layer may, however, additionally also serve decorative purposes in the interior coating of vehicle bodies by also being applied onto the primed interior of the vehicle body outside the floor area. The good mechanical resistance and also the good appearance of the functional layer is advantageous here.

The coating compositions to be used for applying the functional layer furthermore have the advantage of being in line with the more stringent environmental requirements as they are water-based and contain only small quantities of organic solvents.

The following Examples are intended to illustrate the invention in greater detail.

### Examples

### Example 1

### Preparation of a Water-Based Coating Composition

A water-based coating composition according the invention was prepared by admixing the following ingredients:
2.0% by weight of deionized water
33.0% by weight of an aqueous (meth)acrylic latex (Neocryl XK-87, 51% in water)
23.0% by weight of an aqueous butadiene-styrene latex (Lipaton SB5521, 50% in water)
1.0% by weight of a thickener (Latekoll D)
9.0% by weight of titan dioxide (Ti-Pure R-960)
3.0% by weight of a filler (Talkum AT extra)
18.0% by weight of a filler (Blancfixe F)
1.0% by weight of a dispersant additive (Disperbyk 111)
2.0% by weight of N-methyl-pyrrolidone.
8.0% by weight of melamine resin (Cymel 327, 90% in isobutanol)

### Example 2 (Comparison)

### Preparation of a Comparative Water-Based Coating Composition

The same coating composition as described in example 1 has been prepared, except the paint formulation of example 2 did not contain melamine resin.

The coating compositions of example 1 and 2 were airless spray-applied (250 bar) onto CED-coated, with Zn-phosphate pretreated cold rolled steel panels in a dry film thickness of about 1000 microns. After spraying the coated panels were air-dried for 15 minutes and afterwards baked for 60 min at 80° C. in a convection oven.

Two-pack polyurethane adhesive material were applied on the hardened coating in a film thickness of 5 mm.

The coating has then been evaluated in accordance with P 65 47 021 norm of Daimler Crysler (Haftungs- and Bruchbildbeurteilung von Scheiben-Klebstoffsystemen) assigned for measuring cohesive break of the two-component adhesive material after exposure to the critical environments.

Test conditions: The test panel has been stored in a 100% humidity environment at a temperature of 70° C. for a time of 4 days. Afterwards, the test panel was immediately put in a freezing chamber at a temperature of −25° C. for 16 h. After that, the test panel has been reconditioned for 24 h at room temperature and subsequently investigated for adhesive/cohesive failure of the adhesive layer. This has been done by first cutting the glue layer at the interface to the paint layer underneath followed by peeling off the glue layer starting from the cut.

The results of the investigations are summarized in Table 1.

TABLE 1

| Coating composition | *Cohesion break rating |
|---|---|
| Example 1 | 4-5 |
| Example 2 (Comparison) | 1 |

*Rating index:
1: 0% cohesion break (adhesive material detaches completely from the coating interface)
2: 25% cohesion break
3: 50% cohesion break
4: 75% cohesion break
5: 100% cohesion break (adhesive material breaks cohesively, entirely in itself, not at adhesive/coating interface)

The results given in Table 1 clearly show that the use of the comparative coating composition (without melamine resin) in the multilayer structure results in a complete detachment of the adhesive from the coating layer, whereas the use of the coating composition according to the invention (with melamine resin) in the multilayer structure results in a strong adhesion (non-detachment) between the adhesive and the coating layer.

1. Method for the production of a multilayer structure, comprising the steps:
1. Applying a functional coating layer onto an optionally precoated substrate,
2. Curing the coating applied in this manner and
3. Applying an adhesive onto the cured coating,
wherein the functional coating layer is applied from a water-based coating composition which comprises:
A) at least one aqueous polymer latex, selected from the group consisting of (meth)acrylate latex, polydiene latex, polydiene copolymer latex, polystyrene latex, nitrile latex and mixtures thereof, and
B) at least one amino resin.

2. The method of claim 1, wherein the functional layer is applied from a water-based coating composition comprising 10-70 wt. % of component A) and 1-20 wt. % of component B), relative to the entire coating composition, wherein the wt. % are based on the resin solids of component A) and B).

3. The method of claim 2, wherein the functional layer is applied from a water-based coating composition comprising 20-50 wt. % of component A) and 3-12 wt. % of component B), relative to the entire coating composition, wherein the wt. % are based on the resin solids of component A) and B).

4. The method of claim 1, wherein the amino resin B) is a water-dispersible amino resin.

5. The method of claim 4, wherein the amino resin B) is a water-dispersible melamine resin.

6. The method of claim 1, wherein component A) comprises at least one aqueous (meth)acrylate latex.

7. The method of claim 1, wherein component A) comprises at least one aqueous butadiene and/or butadiene copolymer latex.

8. The method of claim 1, wherein component A) comprises at least one aqueous (meth)acrylate latex in combination with at least one aqueous polydiene latex and/or polydiene copolymer latex.

9. The method of claim 8, wherein component A) comprises at least one aqueous (meth)acrylate latex in combination with at least one aqueous butadiene copolymer latex.

10. The method of claim 1, wherein curing in step 2 proceeds at temperatures from ambient temperature to 80° C.

11. The method of claim 1, wherein the substrate is pre-coated with a primer.

12. The method of claim 1, wherein the substrate is a vehicle body.

13. Use of the method of claim 1 for interior coating of vehicles.
